(19) United States
(12) Patent Application Publication
(10) Pub. No.: US 2014/0186799 A1
(43) Pub. Date: Jul. 3, 2014

(54) DENTAL IMPLANT

(71) Applicant: METAL INDUSTRIES RESEARCH & DEVELOPMENT CENTRE, (US)

(72) Inventors: BO-WEI PAN, Kaohsiung (TW); TUNG-LIN TSAI, Kaohsiung (TW); YI-CHIN CHEN, Kaohsiung (TW); SHIEN-NAN KUO, Kaohsiung (TW)

(73) Assignee: METAL INDUSTRIES RESEARCH & DEVELOPMENT CENTRE, Kaohsiung (TW)

(21) Appl. No.: 13/728,630

(22) Filed: Dec. 27, 2012

(51) Int. Cl. A61C 8/00

(52) U.S. Cl. CPC A61C 8/0025; A61C 8/0051; A61C 8/0069; A61C 8/0024
USPC 433/174

(57) ABSTRACT

The invention provides a dental implant including a body portion, an abutment portion and a connection portion. The body portion has a body outer diameter. The connection portion is connected between the body portion and the abutment portion. The body portion, the connection portion and the abutment portion are integrally formed. The connection portion has a first area connected to the body portion. An outer diameter of the first area is less than the body outer diameter of the body portion adjacent to the first area. The connection portion has an indented structure to adhere the alveolar bone and grow the soft tissue, so that a biologic width is formed between the soft tissue and the hard tissue to prevent bacteria in the mouth from invading the alveolar bone tissue, thereby solving the problem of osteanabrosis in conventional dentistry, and satisfying the clinical aesthetic requirement of the anterior teeth.

### BACKGROUND OF THE INVENTION

1. Field of the Invention

The present invention relates to a dental implant, and more particularly to a one-piece dental implant integrally formed.

2. Description of the Related Art

A conventional clinical dental implant generally has a two-piece structure, that is, the dental implant includes an implant and an abutment. When the implant is planted in the alveolar bone of a tooth, a dentist can choose a proper abutment according to the clinical requirement, and lock the abutment to the implant. However, a great variety of abutments are available and the abutments are expensive; moreover, the repeated action of locking the abutment to the implant easily injures an inner hole of the implant, so the abutment fails to be firmly connected to the implant. As a result, bacteria in the mouth penetrate into the inner hole of the implant, causing inflammation near the implant.

A conventional one-piece dental implant has a solid structure. The conventional one-piece dental implant does not have an inner hole and has an abutment structure. The dentist does not need to buy an additional abutment, which not only reduces the complexity of the dental implant surgery and prosthesis, but also reduces the medical cost for patients. However, according to clinical data, after long-term biting, the one-piece dental implant causes serious osteanabrosis, and decreases the height of the gingival tissue, thereby exposing partial dental implant and affecting the aesthetic appearance of the anterior teeth of patient, which may lead to medical dispute between dentist and patient.

Therefore, it is necessary to provide a dental implant to solve the above problems.

### SUMMARY OF THE INVENTION

The present invention provides a dental implant. The dental implant of the invention includes a body portion, an abutment portion and a connection portion. The body portion has at least one thread area and a body outer diameter. The at least one thread area has a plurality of threads. The abutment portion is used to fix a prosthesis. The connection portion is connected between the body portion and the abutment portion. The body portion, the connection portion and the abutment portion are integrally formed. The connection portion has a first area. The first area is connected to the body portion. An outer diameter of the first area is less than the body outer diameter of the body portion adjacent to the first area.

Using that the diameter of the first area is less than the body outer diameter, the connection portion of the dental implant has an indented structure, so as to adhere the alveolar bone and to grow the soft tissue, so that a biologic width is formed between the soft tissue and the hard tissue to prevent bacteria in the mouth from invading the alveolar bone tissue, thereby solving the problem of osteanabrosis in the conventional dentistry, and satisfying the clinical aesthetic requirement of the anterior teeth.

### BRIEF DESCRIPTION OF THE DRAWINGS

FIG. 1 shows a schematic view of a dental implant according to the present invention;

FIG. 2 shows a schematic partial enlarged view of a dental implant according to the present invention; and

FIG. 3 shows a schematic top view of a dental implant according to the present invention.

### DETAILED DESCRIPTION OF THE INVENTION

The terms “upper” and “lower” mentioned in the specification are irrelevant to the gravity. The term “upper” indicates the property of being close to an occlusal surface or an incisal end of a connected prosthesis, and the term “lower” indicates an opposite property.

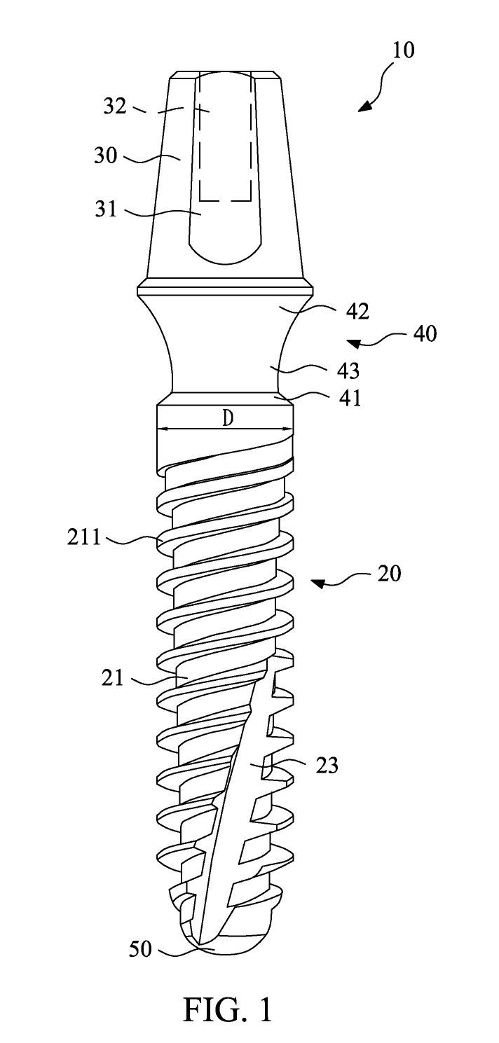

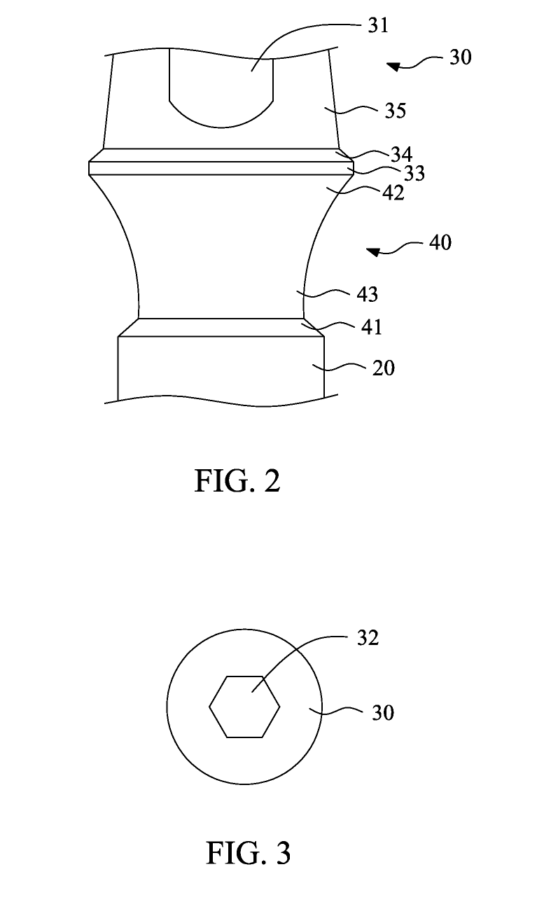

FIG. 1 shows a schematic view of a dental implant according to the present invention. FIG. 2 shows a schematic partial enlarged view of a dental implant according to the present invention. Referring to FIG. 1 and FIG. 2, a dental implant 10 of the present invention includes a body portion 20, an abutment portion 30 and a connection portion 40. The body portion 20, the connection portion 40 and the abutment portion 30 are integrally formed as a one-piece dental implant.

The body portion 20 has at least one thread area 21 and a body outer diameter D. The at least one thread area 21 has a plurality of threads 211, and the dental implant 10 is planted into a bone of the human body through the threads 211. The body outer diameter D is an outer diameter of an uppermost non-threaded part of the body portion 20.

The dental implant 10 of the present invention further includes a bottom portion 50 disposed below the body portion 20. The bottom portion 50 is arc-shaped, so as to scatter a biting force. The body portion 20 of the dental implant 10 further includes a cutting groove 23, vertically formed among a part of the threads and extending to the bottom portion 50. In this embodiment, the cutting groove 23 is spiral-shaped, and is fitted with the arc-shaped bottom portion 50, so as to provide small-torsion implant and neuroprotection, thereby preventing nerves from being damaged during the implanting process.

In this embodiment, the body portion 20 only has one thread area 21. In other embodiments, the body portion may further include a fine thread area and a coarse thread area, and the fine thread area is mounted above the coarse thread area.

The abutment portion 30 is used to fix a prosthesis (not shown in the figure). The connection portion 40 is connected between the body portion 20 and the abutment portion 30. The connection portion 40 has a first area 41. The first area 41 is connected to the body portion 20. An outer diameter of the first area 41 is less than the body outer diameter D, that is, the outer diameter of the first area 41 is less than the body outer diameter D of the body portion 20 adjacent to the first area 41.

Using that the diameter of the first area 41 is less than the body outer diameter D, the connection portion 40 of the dental implant 10 has an indented structure, so as to adhere the alveolar bone and to grow the soft tissue, so that a biologic width is formed between the soft tissue and the hard tissue to prevent bacteria in the mouth from invading the alveolar bone tissue, thereby solving the problem of osteanabrosis in the conventional dentistry, and satisfying the clinical aesthetic requirement of the anterior teeth.

In this embodiment, the connection portion 40 further includes a second area 42 and a middle area 43. The second area 42 is connected to the abutment portion 30. The middle area 43 is disposed between the first area 41 and the second area 42. A maximum outer diameter of the second area 42 is less than an outer diameter of abutment portion 30 adjacent to the second area 42. The outer diameter of the first area 41 gradually decreases along a direction towards the middle area 43, and the outer diameter of the second area 42 gradually decreases along a direction towards the middle area 43. A minimum value of the outer diameter of the first area 41 and the outer of second area 42 is 3 mm.

In this embodiment, the second area 42 is arc-shaped and gradually shrinks towards the middle area 43. In other embodiments, the second area 42 can be tapered.

In this embodiment, the first area 41 is slope-shaped and gradually shrinks towards the middle area 43. In other embodiments, the first area 41 can be arc-shaped, indented or vertical.

FIG. 3 shows a schematic top view of a dental implant according to the present invention. Referring to FIG. 1 and FIG. 3, in this embodiment, the abutment portion 30 is a tapered structure, and further includes at least one recess structure 31 and an inner hole 32. The recess structure 31 is recessed from the periphery of the tapered structure, so as to further fix the prosthesis and resist the biting force.

The inner hole 32 is provided with an opening on a top surface of the abutment portion 30, and extends downward along an axial direction of the dental implant 10. The inner hole 32 is hexagonal, so as to be fitted with a hexagonal tool (not shown in the figure). The hexagonal tool can be disposed in the inner hole to plant the dental implant 10 of the present invention into the alveolar bone.

While several embodiments of the present invention have been illustrated and described, various modifications and improvements can be made by those skilled in the art. The embodiments of the present invention are therefore described in an illustrative but not in a restrictive sense. It is intended that the present invention should not be limited to the particular forms as illustrated and that all modifications which maintain the spirit and scope of the present invention are within the scope defined in the appended claims.

What is claimed is:

1. A dental implant, comprising:
a body portion, having at least one thread area and a body outer diameter, the at least one thread area having a plurality of threads;
an abutment portion, for fixing a prosthesis;
a connection portion, connected between the body portion and the abutment portion;
a bottom portion disposed below the body portion, and the bottom portion being arc-shaped; and
a cutting groove, vertically formed among a part of the threads and extending to the bottom portion,
wherein the body portion, the connection portion and the abutment portion are integrally formed, the connection portion has a first area, the first area is connected to the body portion, an outer diameter of the first area is less than the body outer diameter of the body portion adjacent to the first area,
wherein the cutting groove is spiral-shaped, and is fitted with the arc-shaped bottom portion,
wherein the connection portion further comprises a second area and a middle area, the second area is connected to the abutment portion, the middle area is disposed between the first area and the second area, an outer diameter of the second area is less than an outer diameter of abutment portion adjacent to the second area,
wherein the abutment portion comprises a flat ring section, a first tapered section and a second tapered section, the first tapered section is disposed between the flat ring section and the second tapered section, and an outer diameter of the first tapered section gradually decreases along a direction towards the second tapered section.

2. (canceled)

3. The dental implant according to claim 1, wherein the outer diameter of the first area gradually decreases along a direction towards the middle area.

4. The dental implant according to claim 1, wherein the outer diameter of the second area gradually decreases along a direction towards the middle area.

5. The dental implant according to claim 1, wherein the second area is arc-shaped or tapered.

6. The dental implant according to claim 1, wherein the first area is slope-shaped, arc-shaped, indented or vertical.

7. (canceled)

8. (canceled)

9. The dental implant according to claim 1, wherein the abutment portion is a tapered structure, and comprises at least one recess structure and an inner hole, the recess structure is recessed from a periphery of the tapered structure, the inner hole is provided with an opening on a top surface of the abutment portion, and extends downward.

10. The dental implant according to claim 1, wherein the body portion further comprises a fine thread area and a coarse thread area, and the fine thread area is mounted above the coarse thread area.
